(19) United States
(12) Patent Application Publication
(10) Pub. No.: US 2015/0122746 A1
(43) Pub. Date: May 7, 2015

(54) METHOD AND INSTALLATION FOR THE THERMAL HYDROLYSIS OF SLUDGE

(71) Applicant: Veolia Water Solutions & Technologies Support, Saint-Maurice Cedex (FR)

(72) Inventors: Delphine Nawawi-Lansade, Courbevoie (FR); Malik Djafer, Boulogne-Billancourt (FR); Julian Chauzy, Antony (FR)

(73) Assignee: Veolia Water Solutions & Technologies Support, Saint-Maurice Cedex (FR)

(21) Appl. No.: 14/400,300

(22) PCT Filed: May 2, 2013
(86) PCT No.: PCT/EP2013/059179

§ 371 Date: Nov. 10, 2014

(30) Foreign Application Priority Data
May 10, 2012 (FR) 1254303

(51) Int. Cl. C02F 11/18

(52) U.S. Cl. CPC C02F 11/18; C02F 2103/34
USPC 210/774; 210/177

(57) ABSTRACT

Provided is a method for performing thermal hydrolysis of sludge in a cyclic manner. A sludge stream is directed into one reactor during a first cycle and in a second cycle sludge is directed into another reactor. Each reactor has a sludge recirculation loop associated therewith. Flash steam from one reactor is transferred to the other reactor to pre-heat the sludge. The sludge in each reactor is recirculated through the circulation loop during each cycle of thermal hydrolysis. Live steam is directed into each reactor to raise the pressure and temperature within the reactor in order to enable the thermal hydrolysis process to take place.

This application is a U.S. National Stage Application of PCT Application No. PCT/EP2013/059179, with an international filing date of 2 May 2013. Applicant claims priority based on French Patent Application No. 1254303 filed 10 May 2012. The subject matter of these applications is incorporated herein.

### 1. FIELD OF THE INVENTION

The invention pertains to the field of the treatment of sludges highly charged with fermentable organic matter and especially that of:
sludges derived from the processes of depollution of urban or industrial wastewater;
organic wastes;
mixtures of sludges derived from processes of depollution of urban or industrial wastewater and organic wastes.

### 2. PRIOR ART

Currently, a part of the sludges produced by the cleansing stations is recycled into the agricultural sector while another part is generally either put into landfills or incinerated. Since the production of these sludges is becoming ever greater, it is necessary that they should not present any danger for the environment and human health. Indeed, these sludges contain germs some of which are pathogenic (coliform bacteria, salmonella, helminth eggs etc). In addition, they are fermentable and are the source of gases (amines, hydrogen sulfide, mercaptans), which cause olfactory nuisance. These considerations explain the need to implement at least one step, in the above-mentioned treatment systems for stabilizing these sludges, aimed at obtaining sludges that no longer evolve or at least evolve slowly both on the biological plane and as on the physical/chemical plane. Other preoccupations relate to the wish to reduce the volume of the sludges and recycle the sludges in the form of biogas.

Various methods have been proposed in the prior art to treat these sludges, among them:
aerobic digestion;
anaerobic digestion;
chemical conditioning;
thermal conditioning;
thermal hydrolysis.
   It is to this last-named type of treatment that the invention pertains.

The thermal hydrolysis of sludges consists in treating these sludges at high temperature and under pressure so as to sanitize them (i.e. very greatly reduce their microorganism content), solubilize a major part of the particulate matter and convert the organic matter that they contain into biodegradable, soluble COD (alcohols, aldehydes, volatile fatty acids).

One particularly efficient technique for the hydrolysis of sludges implements at least two reactors working in parallel, in each of which the sludges undergo a full cycle of thermal hydrolysis.

Each of the cycles of thermal hydrolysis implemented in a reactor comprises the steps for feeding sludges to be treated into the reactor, injecting live steam therein to bring the sludges to a pressure P and a temperature T enabling hydrolysis, maintaining them at this pressure P and this temperature T for a certain period of time, suddenly bringing the sludges to a pressure close to atmospheric pressure in releasing flash steam which is recycled to pre-heat the sludges to be treated of the reactor working in parallel and empty the reactor of the sludges thus hydrolyzed.

According to this technique, it is planned that the cycle will be staggered time from one reactor to another to use the flash steam produced from one reactor to inject it into the other reactor.

Such an implementation makes it possible to take advantage of the flash steam produced in one of the reactors to feed steam into the other reactor.

This type of method, which removes the need to make the sludges travel from one reactor to another to perform the different steps of thermal hydrolysis, has several advantages. In particular, it simplifies the plants needed to implement the method, reduces the speed of clogging of these plants, minimizes the odors that can be produced during the passage of the sludges from one reactor to another and reduces live steam requirements. However, it has some limitations.

### 3. DRAWBACKS OF THE PRIOR ART

This type of method for the thermal hydrolysis of sludges can be improved. This is especially the case when it is implemented in small-sized or medium-sized plants, i.e. plants treating a daily volume of sludges smaller than 10 m³ for about 10,000 equivalent inhabitants.

In thermal hydrolysis, the main item of cost/expenditure relates to the quantity of steam injected into the sludges. At the sizing level, this affects the size of the steam-producing plants (boilers, steam generators, steam recovery equipment, piping systems, etc) implemented for this purpose. At the exploitation level, this affects the consumption of fuel to generate steam. It is therefore important to reduce the quantity of steam used to treat sludges to the utmost.

The quantity of steam to be injected into a sludge in order to take it to the temperature desired in order to carry out its thermal hydrolysis is linked to its concentration in dry matter. Sludges are indeed constituted by a mixture of dry matter and water. When the sludges are heated, therefore, the temperature of both the dry matter and of the water needs to be heated. The result of this is that the lower the concentration of the sludge, i.e. the lower is its viscosity or its dryness, the greater is the volume of sludge to be heated and therefore the greater is the quantity of steam needed to heat it. This increases the consumption of live steam and therefore increases the consumption of fuel (biogas, oil, natural gas, etc) used to produce this live steam.

Furthermore, the risk of odors being released at all levels of the sludge treatment system is all the greater as the volume of the hydrolyzed sludges is great.

It is therefore necessary to treat sludges that are as concentrated as possible, i.e. that have high viscosity or dryness, in order to limit the consumption of steam and reduce the production of hydrolyzed sludges and therefore the emanation of odors.

The transfer of steam into highly concentrated sludge however causes problems. Indeed, it has been noted especially in existing methods that the transfer of steam into highly concentrated sludges is not optimal. This problem of transfer of steam is especially encountered when injecting flash steam into sludges to be treated, at the start of thermal hydrolysis. This can be explained by the fact that the transfer of steam into sludges is linked to their concentration, the transfer being all the smaller as the concentration of the sludges is great. The concentration of sludges to be treated should not be excessively high so as not to hinder the transfer of steam.

Ultimately, the optimizing of the thermal hydrolysis of sludges in terms of reduction of steam consumption assumes that the following two antagonistic factors are taken into consideration:
the greater the concentration of the sludge, the smaller is the volume to be treated (and the smaller the risks of emanation of odors) and the smaller is the quantity of steam to be injected to heat the sludges,
BUT the greater the concentration of the sludge, the more difficult it is to carry out this transfer of steam and therefore the more difficult it is to use a small quantity of steam: this is therefore a boundary observed in prior-art methods whereby the sludges are not concentrated beyond a certain value failing which there the risk of having a poor transfer and an excessively high consumption of steam.

### 4. GOALS OF THE INVENTION

The invention is aimed especially at overcoming these drawbacks of the prior art.

More specifically, it is a goal of the invention to provide a technique of thermal hydrolysis of sludges that leads to the limiting, in at least one embodiment, of the consumption of steam.

It is another goal of the invention, in at least one embodiment, to implement a technique of this kind that reduces steam heat losses, especially flash steam heat losses.

The invention again is aimed at procuring a technique of this kind that makes it possible, in at least one embodiment, to reduce emanations of odors outside the reactors.

It is another goal of the invention to procure a technique of this kind that makes it possible, in at least one embodiment, to provide for an efficient hydrolysis of sludges having high dryness in ensuring efficient transfer of the steam with said sludge in a confined environment improving steam/sludge exchanges enabling especially fast condensation of steam in sludge, thus limiting steam consumption.

It is another goal of the invention, in at least one embodiment, to improve the viscosity of the sludge before the injection of steam in improving especially the mixture of hydrolyzed sludges and fresh sludges.

The invention is also aimed, in at least one embodiment, at procuring a technique of this kind that is reliable and/or low cost and/or compact and/or simple to implement.

### 5. SUMMARY OF THE INVENTION

These goals as well as others that shall appear here below are achieved by means of a method for thermal hydrolysis of sludges to be treated, said method being carried out in at least two reactors working in parallel, in each of which the sludges undergo a full cycle of thermal hydrolysis, said cycle comprising the steps consisting in feeding said sludges to be treated into one reactor, injecting therein flash steam coming from the other reactor to preheat the sludges, injecting therein live steam to bring them to a pressure P and to a temperature T enabling hydrolysis, maintaining them at said pressure P and at said temperature T for a certain time, bringing said sludges to a pressure close to atmospheric pressure in order to release flash steam and cool the sludges, and emptying said reactor of said sludges thus hydrolyzed, said cycle being staggered in time from one reactor to another to use the flash steam produced from one reactor to inject it into the other reactor.

According to the invention, such a method comprises a step consisting in extracting a part of the sludges present in each of the reactors and reintroducing them into the corresponding reactor.

Thus, the invention relies on a wholly original approach, which consists of the extraction of a part of the sludges contained in a thermal hydrolysis reactor and then in reintroducing them into this reactor. In other words, the invention consists of the circulation of a part of the content of a thermal hydrolysis reactor in itself, i.e. the re-introduction, into a thermal hydrolysis reactor, of sludges that have been extracted from this reactor.

The pressures mentioned are expressed in effective pressure values.

The at least partly hydrolyzed sludges contained in a reactor have dryness below that of the sludges to be treated introduced into the reactor and a temperature above that of these sludges. Thus, their viscosity is lower than that of the sludges to be treated. Through this invention, the mixture of partially hydrolyzed sludges with sludges to be treated is improved, and the mixture is thus perfectly homogenous, and the viscosity of the mixture is thus optimized.

Furthermore, depending on the nature of the means implemented to recirculate the sludges (a pump for example), the viscosity of the mixture is diminished by mechanical effect when it passes through these sludges.

The transfer of steam into the sludges increases inversely proportionally to their viscosity. The implementation of the invention therefore improves the transfer of steam into the sludges. The heat losses and the steam consumption can thus be reduced.

Given that the heat losses, for example the leakages of steam out of the reactors, are reduced, the technique of the invention also limits olfactory nuisance throughout the sludge treatment system.

The inventors have thus been able to optimize the thermal hydrolysis of the sludges by circumventing two limiting factors:
the first factor in which the greater the dryness of the sludges to be treated, the less efficient is the transfer of steam into the sludges and therefore the lower is the efficiency of the hydrolysis;
the second factor according to which the lower the dryness of the sludges to be treated, the greater is the volume of sludges to be treated and the higher is the consumption of steam and therefore the lower is the efficiency of the hydrolysis.

According to an advantageous characteristic, at least a part of said live steam and/or said flash steam is injected into the sludges extracted from the reactors before they are reintroduced into the corresponding reactor.

By injecting steam into the recirculation loop, which is a confined environment, we obtain an improvement in the steam/sludge exchanges enabling especially fast and efficient condensation of the steam in the sludge, thus limiting the consumption of steam.

The improvement of the transfer of steam into the sludges obtained by such an injection of steam into the sludge recirculation loop is such that the technique according to the invention efficiently hydrolyzes sludges that are more concentrated than those usually treated in prior-art methods. The sludges to be treated by the technique of the invention have a dryness preferably ranging from 14% to 30%.

Said sludges to be treated could be directly introduced into the reactors.

According to an advantageous characteristic of the invention, said sludges to be treated are mixed with said extracted sludges before feeding the reactors.

The sludges to be treated are thus mixed with partly hydrolyzed sludges, having lower dryness and higher temperature, before they are introduced into the reactor. The dryness of the mixture of the sludges introduced into the reactor is therefore lower than that of the sludges to be treated and the temperature of the mixture of sludges introduced into the reactor is therefore higher than that of the sludges to be treated. By these two phenomena, the transfer of steam into the sludges inside the reactor is thus improved as compared with the case where the sludges to be treated are directly introduced into the reactor. This implementation thus improves the performance of the hydrolysis of the sludges while limiting steam consumption, in increasing the dryness of the sludges to be treated and reducing olfactory nuisance.

According to first advantageous characteristic, 0% to 100% of the flash steam produced in one reactor, and preferably 25% to 75%, is introduced into the sludges extracted from another reactor before they are reintroduced into this reactor.

According to a second advantageous characteristic, 0 to 100% of the live steam needed to conduct a cycle in a reactor, and preferably 0% to 50%, is introduced into the sludges that are extracted from it before being reintroduced therein.

According to these two variants, the remainder of the flash steam and/or live steam is then introduced directly into the reactor.

The direct introduction, into the sludges extracted from a reactor, of such a proportion of the total quantity of flash steam and/or live steam needed to carry out hydrolysis in the reactor gives efficient results in terms of hydrolysis of the sludges, reduction of the steam consumption, reduction of olfactory nuisance and reduction of the dryness of the sludge to be treated.

According to a preferred characteristic of the invention, the injection of flash steam and the step consisting in feeding the sludges to be treated into the reactor take place simultaneously.

The time of a full cycle of sludge hydrolysis can thus be reduced, contributing to improving productivity.

According to an advantageous characteristic of the invention, the pressure P ranges from 3 to 12 bars, and said temperature T ranges from 140 to 180° C.

According to an advantageous characteristic, the pressure of the flash steam ranges from 1 to 12 bars.

The invention also covers a plant for implementing the method according to any one of the variants described here above. Such a plant comprises at least two thermal hydrolysis reactors mounted in parallel, means for conveying sludges to be treated into each of said reactors, means for discharging hydrolyzed sludges from each of said reactors, means for injecting enabling live steam to be injected alternately into each of said reactors and means for conveying and injecting flash steam coming from one reactor to the other reactor.

A plant according to the invention also comprises means for extracting a part of the sludges present in each of the reactors, and means for reintroducing, into the corresponding reactor, sludges that have been extracted from it.

Such a plant advantageously comprises means for injecting live steam and/or flash steam leading out between said means for extracting and said means for reintroducing.

According to one variant, said means for conveying sludges to be treated open directly into each of the reactors.

According to another advantageous variant, said means for conveying sludges to be treated open out between said means for extracting and said means for reintroducing.

### 6. LIST OF FIGURES

Other features and advantages of the invention shall appear more clearly from the following description of preferred embodiments, given by way of simple illustratory and non-exhaustive examples, and from the appended drawings, of which:

FIG. 1 illustrates an example of a plant comprising two reactors for implementing a method according to the invention, comprising means for conveying sludges to be treated directly into the reactors;

FIG. 2 illustrates an example of a plant comprising two reactors for implementing a method according to the invention, which comprises means for conveying sludges to be treated that lead into loops for the recirculation of sludges in the reactors;

FIG. 3 illustrates a plant implemented during trials performed to verify the efficiency of a technique according to the invention;

FIG. 4 illustrates the curve representing the steam consumption as a function of the dryness of the sludges to be treated during the implementing of thermal hydrolysis according to the prior art and according to the invention.

### 7. DESCRIPTION OF ONE EMBODIMENT OF THE INVENTION

7.1. Reminder of the Principle of the Invention

The general principle of the invention is based on the recirculation, in a hydrolysis reactor, of a part of the sludges that it contains. It consists, in other words, in extracting a part of the sludges contained in a thermal hydrolysis reactor and then reintroducing these sludges into this reactor.

Because the extracted sludges have lower dryness, the transfer of steam into the sludges is improved.

The invention thus reduces heat losses and therefore reduces the consumption of steam and, as the case may be, the consumption of biogas used to produce this steam as well as olfactory nuisance. It also makes it possible, so long as the transfer of steam into the sludges is promoted, to more efficiently hydrolyze sludges to be treated, the dryness of which is relatively high.

7.2. Treatment Plants

7.2.1. Example of a First Embodiment of a Plant According to the Invention

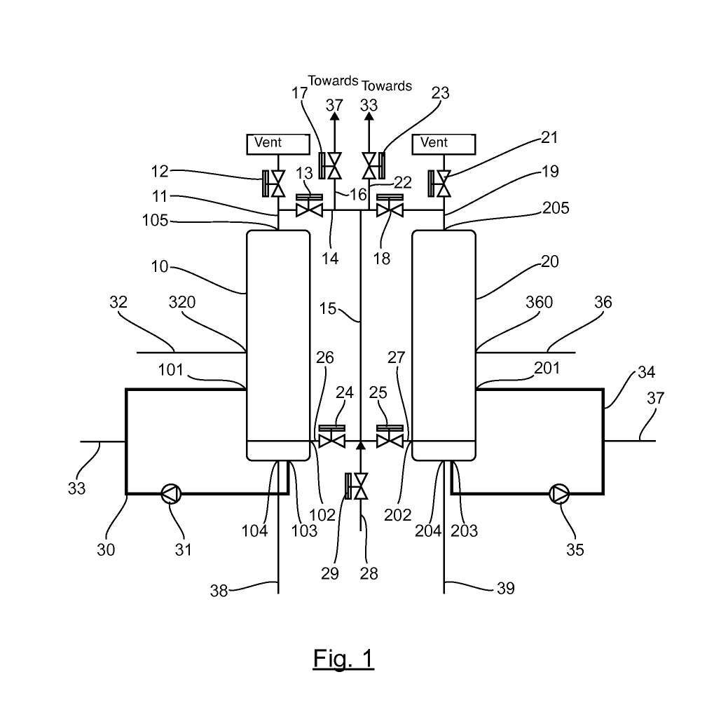

Referring to FIG. 1, we present a first embodiment of a plant for implementing a method for the thermal hydrolysis of sludges according to the invention.

Thus, as shown in this FIG. 1, such a plant comprises a first reactor 10 and a second reactor 20.

The first reactor 10 comprises a first sludge inlet 320, a steam inlet 102, an outlet 103 for sludges to be recirculated, an outlet 104 for hydrolyzed sludges, and a flash steam outlet 105. It comprises a second sludge inlet 101.

The second reactor 20 comprises a first sludge inlet 360, a steam inlet 202, an outlet 203 for sludges to be recirculated, an outlet 204 for hydrolyzed sludges and a flash steam outlet 205. It comprises a second sludge inlet 201.

The outlet 105 is connected to a conduit 11 for extracting flash steam, of which one outlet is connected to a valve 12 and the other outlet is connected to a valve 13. The outlet of the valve 12 is connected to a vent. The outlet of the valve 13 is connected to a conduit 14. The conduit 14 is connected to a conduit 15. A conduit 16 is connected at one of its ends to the conduit 14 and the other one of its ends to a valve 17, the outlet of which is connected to a conduit 37 for conveying flash steam and/or live steam.

The conduit 14 is connected to another valve 18. The valve 18 is connected to another conduit 19 for extracting flash steam. The outlet 205 is connected to the conduit 19 for extracting flash steam. This conduit 19 is also connected to a valve 21, the outlet of which is connected to a vent. A conduit 22 is connected at one of its ends to the conduit 14 and the other one of its ends to a valve 23, the outlet of which is connected to the conduit for conveying flash steam and/or live steam 33.

The conduit 14 opens into the conduits 16 and 23. This conduit 14 is situated on either side of the conduit 15.

The conduit 15 is connected to a valve 24 and to a valve 25 which are respectively connected to a conduit 26 and a conduit 27.

The conduit 26 is connected to inlet 102 of the first reactor 10.

The conduit 27 is connected to the inlet 202 of the second reactor 20.

The conduit 15 is connected to a conduit for conveying live steam 28 via a valve 29.

A conduit 32 for conveying sludges to be treated and a conduit 36 for conveying sludges to be treated open into the first reactor 10 and the second reactor 20 respectively via inlets 320 and 360.

One recirculation loop comprises a conduit 30, the inlet of which is connected to the outlet 103 of the first reactor 10 and the outlet of which opens into the inlet 101 of the first reactor 10. A pump 31 is mounted on this conduit 30. The conduit 33 for conveying flash steam and/or live steam opens into the conduit 30.

Another recirculation loop comprises a conduit 34, the inlet of which is connected to the outlet 203 of the second reactor 20 and the outlet of which opens into the inlet 201 of the second reactor 20. A pump 35 is mounted on this conduit 34. The conduit for conveying flash steam and/or live steam 37 opens into the conduit 34.

A conduit 38 for extracting hydrolyzed sludges is connected to the outlet 104 of the first reactor 10. A conduit 39 for extracting hydrolyzed sludges is connected to the outlet 204 of the second reactor 20.

The conduits 28, 33 and 37 are connected to means for producing live steam such as a boiler that is not shown.

Control means (not shown) are used to control the valves, the injection of steam and sludges into the reactors as well as the extraction of hydrolyzed sludges from the reactors.

7.2.2. Example of a Second Embodiment of a Plant According to the Invention

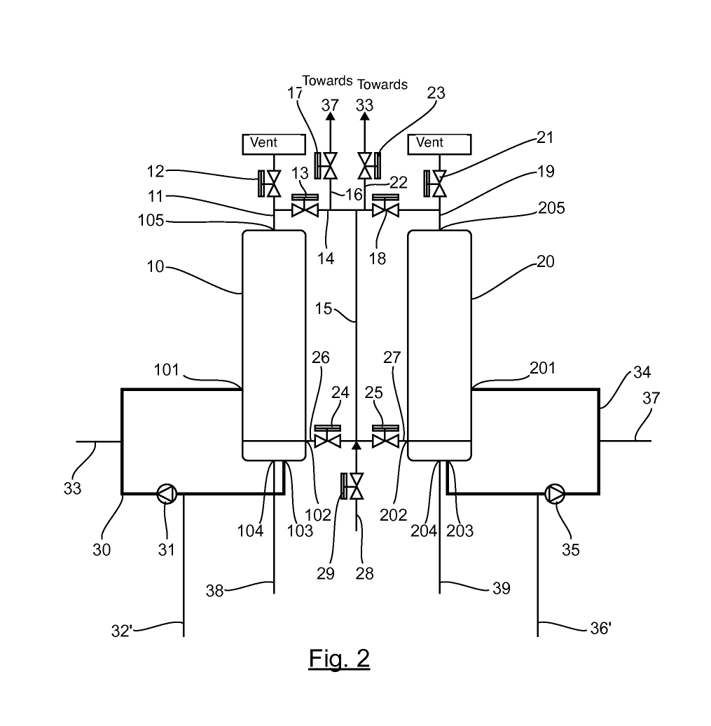

Referring to FIG. 2, we present a second embodiment of a plant for implementing a method for the thermal hydrolysis of sludges according to the invention.

As shown in this FIG. 1, such a plant is distinguished from the plant according to the first embodiment by the fact that the conduits 32, 36 for conveying sludges to be treated, which open respectively into the first reactor 10 and second reactor 20, are eliminated here and replaced by conduits 32′, 36′ for conveying sludges to be treated that respectively open into the recirculation conduits 30, 34.

7.3. Methods of Treatment

7.3.1. Example of a Method Implementing the Plant According to the First Embodiment

When implementing a method according to the invention, cycles of thermal hydrolysis are implemented successively in each of the first and second reactors 20.

Each cycle of thermal hydrolysis comprises:
a step for feeding sludges to be treated into one reactor,
a step for injecting, into this reactor, flash steam coming from the other reactor to pre-heat the sludges that are located therein and cool this reactor. This step can be performed simultaneously with the step for feeding sludges or it can be performed in succession,
a step for injecting live steam to take the sludges to be treated to the pressure P ranging from 3 to 12 bars and to the temperature T ranging from 140° C. to 180° C. enabling hydrolysis;
a step for keeping the sludges at the pressure P and the temperature T for a time Tps ranging from 10 to 60 minutes;
a step for bringing the sludges back to a pressure close to atmospheric pressure by releasing flash steam. This step takes place simultaneously with the step for injecting flash steam into the other reactor;
a step for emptying the reactor of the sludges thus hydrolyzed.

The cycles are implemented in each of these reactors in a manner that is staggered in time in order to inject, into one reactor, the flash steam produced in the other reactor at the end of the cycle.

In a first stage, sludges to be treated are introduced via the conduit 32 into the first reactor 10.

The pump 31 is put into operation in order to extract a part of the sludges contained in the first reactor 10 through the outlet 103 and to reintroduce them via the conduit 30 and the inlet 101.

Flash steam coming from the reactor 20 is injected simultaneously with the feeding of sludges to the reactor 10:
either in the conduit 30 via the conduits 19, 14, 22 and 33;
or at the inlet 102 of the reactor 10 via the conduits 19, 14, 15 and 26.

After the feeding of sludges to the first reactor 10 is completed, the arrival of sludges to be treated via the conduit 32 is stopped.

When the steps for feeding sludges and injecting flash steam are completed, live steam is injected:
either into the first reactor 10 via the conduits 28, 26 and the inlet 102;
or into the conduit 30 via the conduit 33.

The pump 31 continues to be operated so that a part of the sludges contained in the first reactor 10 is extracted via the outlet 103 and recirculated in the first reactor 10. If necessary, the live steam is injected into the sludges via the conduit 33.

At the same time, the injection of live steam continues until the sludges are gradually carried to a pressure P and to a temperature T:
either in a first reactor 10 via the conduits 28, 26 and the inlet 102;
or in the conduit 30 via the conduit 33.

When these conditions are achieved, the injections of live steam are stopped and the pump 31 is stopped so that the recirculation of sludges via the conduit 30 is stopped. The sludges are then kept at the pressure P and the temperature T for a time Tps to enable thermal hydrolysis.

When the thermal hydrolysis is completed in the first reactor 10, the pressure of the hydrolyzed sludges is rapidly released until pressure close to atmospheric pressure is achieved, thus producing flash steam.

At the same time, the sludges to be treated are introduced into the second reactor 20 via the conduit 36. The pump 35 is put into operation in order to extract a part of the sludges contained in second reactor 20 through the outlet 203 and reintroduce them via the conduit 34 and the inlet 201.

The flash steam thus produced in the first reactor 10 is extracted from the outlet 105 and introduced simultaneously with the feeding of sludges to the second reactor 20:
either in the second reactor 20 via the conduits 11, 14, 15, 27 and the inlet 202;
or in the conduit 34 via the conduits 11, 14, 16 and 37.

When all the flash steam coming from the first reactor 10 is injected into the second reactor 20, the hydrolyzed sludges are extracted from the first reactor 10 via the outlet 104 and the conduit 38.

After the feeding of the second reactor 20 is completed, the arrival of sludges to be treated via the conduit 36 is stopped.

When the steps for feeding and injecting flash steam are terminated, live steam is injected:
either into the second reactor 20 via the conduits 28, 27 and the inlet 202;
or into the conduit 34 via the conduit 37.

The pump 35 continues to be operated so that a part of the sludges contained in the second reactor 20 is extracted therefrom via the outlet 203 and then recirculated. If necessary, live steam is injected into these sludges via the conduit 37.

At the same time, the injection of live steam continues until the sludges are gradually carried to a pressure P and a temperature T:
either in the second reactor 20 via the conduits 28, 27 and the inlet 202;
or in the conduit 34 via the conduit 37.

When these conditions are attained, the injections of lives steam are stopped and the pump 35 is stopped so that the recirculation of sludges via the conduit 34 is stopped. The sludges are then maintained at the pressure P and at the temperature T for a period of time Tps to enable thermal hydrolysis.

Each cycle therefore comprises a step of recirculation in which a part of the sludges present in the reactor fed with sludges to be treated is extracted and reintroduced into this reactor. This step of recirculation is preferably implemented during the step for feeding sludges to be treated into the reactor and during the step for injecting flash steam into this reactor. It could also be implemented from the feeding step up to the start of the step in which the sludges are maintained under the pressure P and at the temperature T, also called a maintaining step. In general, the step for recirculation can be implemented at the start of the feeding step and the maintaining step.

When the thermal hydrolysis is completed in the first reactor 20, the pressure of the hydrolyzed sludges is quickly relaxed until it reaches a pressure close to atmospheric pressure, thus producing flash steam.

At the same time, a new step for feeding the first reactor 10 is implemented. Sludges to be treated are introduced via the conduit 12 into the first reactor. The pump 31 is implemented in order to make the sludges circulate inside the conduit 30 and they are introduced into the first reactor 10 via the inlet 101. Flash steam coming from the second reactor is injected into the first reactor 10 or into the conduit 30.

The cycle continues then in the first reactor 10.

A plurality of cycles can thus be implemented in a staggered manner in each of the reactors.

In the case of a starting of the plant, and when there is no flash steam available (since all the reactors are stopped), all the steam injected into the first reactor is live steam.

7.3.2. Example of a Method Implementing a Plant According to the Second Embodiment of the Invention

A method implementing a plant according to the second embodiment of the invention is identical to the one implementing a plant according to the first embodiment except that the sludges to be treated are injected no longer directly into the reactors but into recirculation loops. This injection can take place upstream or downstream to the pumps 31, 35.

7.4. Variants

In one variant, it can be planned that the injection of flash steam will not take place simultaneously with the feeding with sludges to be treated but subsequently.

A plant implemented to carry out a method according to the invention could include more than two reactors within each of which cycles of thermal hydrolysis are implemented in succession, the cycles being staggered from one reactor to another to inject the flash steam produced in one reactor into another reactor within which the cycle has reached this stage.

7.5. Trials

Comparative trials were conducted to verify the efficiency of the technique according to the invention in terms of steam consumption.

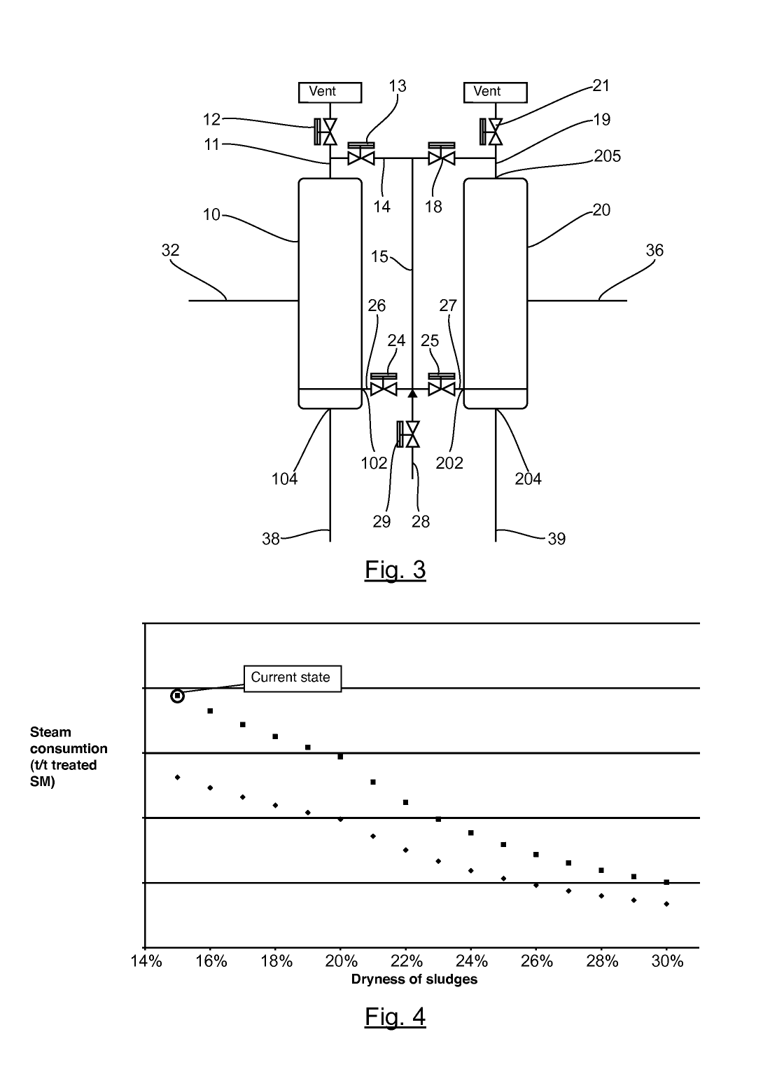

A first series of trials consisted in treating sludges by thermal hydrolysis in the prior-art plant illustrated in FIG. 3, which is comparable to that illustrated in FIG. 1 except that the means for recirculating sludges and injecting steam into extracted sludges which are then reintroduced into the reactor was not implemented.

The consumption of steam according to the dryness of the sludges during these first trials is represented by the squares shown in FIG. 4.

The second series of trials consisted in treating sludges by thermal hydrolysis in a plant comparable to the one illustrated in FIG. 2.

The consumption of steam according to the dryness of the sludges during these second trials is represented by the diamonds of FIG. 4.

Analysis of the curves of FIG. 4 shows that whatever the value of the dryness of the sludges to be treated, implementing the technique according to the invention reduces the consumption of steam. It also reduces the consumption of steam when the dryness of the sludges to be treated increases.

The technique of the invention therefore reduces the consumption of steam and provides efficiently for the thermal hydrolysis of sludges to be treated having a relatively high dryness and, in any case, having a dryness higher than of the sludges treated with the methods of the prior art.

The technique of the invention also avoids the need to implement a pre-heating reactor upstream to the reactors within which the cycles of thermal hydrolysis are implemented. The invention thus enables the sludges to be treated in more compact, low-cost plants.

1-14. (canceled)

15. A method of thermal hydrolyzing on sludge in first and second parallel disposed reactors with the sludge in each reactor undergoing a full cycle of thermal hydrolysis, the method comprising:
feeding sludge to be treated into the first reactor;
injecting flash steam from the second reactor into the first reactor to pre-heat the sludge in the first reactor;
injecting live steam into the first reactor to bring the first reactor to a pressure and temperature that enables thermal hydrolysis of the sludge in the first reactor;
maintaining the pressure and temperature sufficient to carry out thermal hydrolysis in the first reactor for a selected time;
reducing the pressure in the first reactor to approximately atmospheric pressure and releasing flash steam which cools the sludge in the first reactor;
emptying thermal hydrolyzed sludge form the first reactor;
feeding sludge to be treated to the second reactor;
injecting the flash steam produced in the first reactor into the second reactor to pre-heat the sludge in the second reactor;
injecting live steam into the second reactor to bring the second reactor to a pressure and temperature that enables thermal hydrolysis of the sludge in the second reactor;
maintaining the pressure and temperature sufficient to carry out thermal hydrolysis in the second reactor for a selected time;
reducing the pressure in the second reactor to approximately atmospheric pressure and producing the flash steam which cools the sludge;
emptying thermal hydrolyzed sludge from the second reactor;
wherein the thermal hydrolysis cycles carried out in the first and second reactors are staggered such that the flash steam produced in one reactor is injected into the other reactor; and
during at least a part of each thermal hydrolysis cycle in each reactor, extracting a portion of the sludge from the reactor and reintroducing the sludge into the same reactor.

16. The method of claim 15 wherein at least a part of the live steam or flash steam is injected into the sludge extracted from one of the reactors before the sludge is reintroduced into the reactor.

17. The method of claim 15 wherein the sludges to be treated are introduced directly into the reactors.

18. The method of claim 15 including mixing the sludge to be treated with extracted sludge before feeding the sludge to be treated to one of the reactors.

19. The method of claim 15 including mixing flash steam produced by one reactor with sludge extracted from the other reactor before the extracted sludge is reintroduced into the other reactor.

20. The method of claim 15 including mixing the live steam with sludge extracted from one of the reactors before reintroducing the sludge into the reactor.

21. The method of claim 15 wherein feeding sludge to be treated into one reactor and injecting flash steam from the other reactor into the one reactor occurs simultaneously.

22. The method of claim 15 including during the thermal hydrolysis of sludge maintaining the pressure in each reactor to 3 to 12 bars.

23. The method of claim 15 including during the thermal hydrolysis of the sludge maintaining the temperature in each reactor at 140° to 180° C.

24. The method of claim 15 wherein the pressure of the flash steam injected into each reactor ranges from 1 to 12 bars.

25. The method of claim 15 including recirculating sludge from one reactor through a recirculation loop and back into the one reactor while sludge is being fed into the one reactor.

26. The method of claim 25 including injecting flash steam produced in the other reactor into the one reactor while sludge is being recirculated through the recirculation loop and sludge is being fed into the one reactor.

27. A system for thermally hydrolyzing sludge comprising: first and second thermal hydrolysis reactors for thermally hydrolyzing sludge and wherein the first and second thermal hydrolysis reactors are disposed in parallel relationship; each thermal hydrolysis reactor having a discharge outlet for discharging thermal hydrolyzed sludge; the system having a live steam inlet for injecting live steam directly or indirectly into each reactor and wherein the system is configured to alternatively inject live steam into the first and second reactors such that in a first mode of operation live steam is injected directly or indirectly into the first reactor and in a second mode of operation live steam is injected directly or indirectly into the second thermal hydrolysis reactor; a flash steam inlet associated with the first thermal hydrolysis reactor; a flash steam inlet associated with the second thermal hydrolysis reactor; a flash steam interconnecting structure for transferring flash stream from the first reactor directly or indirectly to the second reactor and for transferring flash steam from the second reactor directly or indirectly to the first reactor; and a sludge recycling loop associated with each reactor, the sludge recycling loop including a pump that is operative to withdraw sludge from a respective reactor and to direct the sludge through the sludge recirculation loop and back into the respective reactor.

28. The system of claim 27 including an inlet associated with each recirculation loop associated for directing flash steam into the recirculation loop.

29. The system of claim 27 including an inlet associated with each sludge recirculation loop for directing live steam directly into the recirculation loop.

30. The method of claim 15 including homogenizing the sludge in one of the reactors by withdrawing partially hydrolyzed sludge from the one reactor, directing the withdrawn sludge through a recirculation loop and returning the withdrawn sludge to the one reactor where the sludge that is returned is mixed with sludge that is being fed into the one reactor.

31. The method of claim 30 including enhancing the condensation of steam in the sludge by injecting either the live steam or flash steam into the recirculation loop and mixing the live steam or flash steam with the sludge being recirculated through the recirculation loop.

32. The method of claim 15 including directing sludge from each reactor through a recirculation loop and back into the reactor and the method further includes feeding the sludge to be treated into the recirculation loop such that the sludge to be treated is mixed with the sludge being directed through the recirculation loop before reaching the reactor.

33. A method of hydrolyzing sludge in system having first and second thermal hydrolysis reactors and first and second sludge recirculation loops with the first recirculation loop being associated with the first reactor and the second recirculation loop being associated with the second reactor, the method comprising: feeding sludge into the first reactor or into the first recirculation loop; pre-heating the sludge in the first reactor by directing flash stream from the second reactor into the first reactor or into the first recirculation loop; injecting live steam into the first reactor or into the first recirculation loop and increasing the temperature and pressure in the first reactor sufficient to thermally hydrolyze the sludge in the first reactor; emptying the thermally hydrolyzed sludge from the first reactor; feeding sludge into the second reactor or into the second recirculation loop; pre-heating the sludge in the second reactor by directing flash steam from the first reactor into the second reactor or into the second recirculation loop; injecting live steam into the second reactor or into the second recirculation loop and increasing the temperature and pressure in the second reactor sufficient to thermally hydrolyze the sludge in the second reactor; emptying the thermally hydrolyzed sludge from the second reactor; wherein the method is carried out in cycles wherein in a first cycle sludge is thermally hydrolyzed in the first reactor and thereafter in a second cycle sludge is thermally hydrolyzed in the second reactor; recirculating sludge from the first reactor through the first recirculation loop and back to the first reactor; and recirculating sludge from the second reactor through the second recirculation line and back to the second reactor.

34. The method of claim 33 including injecting flash steam produced in the second reactor into the first recirculation loop and injecting flash steam produced in the first reactor into the second recirculation loop.

35. The method of claim 34 including injecting live steam into the first and second recirculation loops.

36. The method of claim 33 including feeding the sludge directly into the first and second reactors while injecting the flash steam into the first and second recirculation loops.

37. The method of claim 36 including injecting the live steam directly into the first and second reactors.
